(19) United States
(12) Patent Application Publication
(10) Pub. No.: US 2008/0253373 A1
(43) Pub. Date: Oct. 16, 2008

(54) System and Method for Supporting Flexible Overlays and Mobility in Ip Communication and Computer Networks

(75) Inventors: Jordi Ros-Giralt, Aliso Viejo, CA (US); Wei K. Tsai, Irvine, CA (US)

Correspondence Address: OBLON, SPIVAK, MCCLELLAND MAIER & NEUSTADT, P.C., 1940 DUKE STREET, ALEXANDRIA, VA, 22314, US

(73) Assignee: IST International Inc., Aliso Viejo, CA (US)

(21) Appl. No.: 12/066,533

(22) PCT Filed: Sep. 13, 2006
(86) PCT No.: PCT/US06/35630

§ 371 Date: Mar. 12, 2008

Related U.S. Application Data
(60) Provisional application No. 60/716,815, filed on Sep. 13, 2005.
(60) Provisional application No. 60/756,656, filed on Jan. 5, 2006.
(60) Provisional application No. 60/774,502, filed on Feb. 16, 2006.
(60) Provisional application No. 60/774,720, filed on Feb. 16, 2006.
(60) Provisional application No. 60/790,240, filed on Apr. 6, 2006.
(60) Provisional application No. 60/791,689, filed on Apr. 12, 2006.

(51) Int. Cl. H04L 12/56

(52) U.S. Cl. 370/392

(57) ABSTRACT

There is provided a system and method for providing a simple yet flexible overlay network on top of any IP networks to enable diverse network applications whereby much of the rigidities of IP protocol suite are eliminated without any modifications to the applications. In particular, the system includes: a plurality of c-nodes; one or more source terminal nodes connected to an IP network; and one or more destination terminal nodes connected to the IP network. Here, the source terminal nodes send IP packets over the plurality of c-nodes to the destination terminal nodes to accomplish arbitrary communications between arbitrary groups of the source terminal nodes to arbitrary groups of the destination terminal nodes. More specifically, a method employing the system utilizes the concept of connection ID and headers that can be inserted anywhere in the IP packet.

### CROSS-REFERENCE TO RELATED APPLICATIONS

This application claims the benefit of U.S. Provisional Application No. 60/716,815, filed on Sep. 13, 2005; U.S. Provisional Application No. 60/774,720, filed on Feb. 16, 2006; U.S. Provisional Application No. 60/790,240, filed on Apr. 6, 2006; U.S. Provisional Application No. 60/756,656, filed on Jan. 5, 2006; U.S. Provisional Application No. 60/774,502, filed on Feb. 16, 2006; and U.S. Provisional Application No. 60/791,689, filed on Apr. 12, 2006.

### FIELD OF THE INVENTION

The present invention relates generally to a system and method for flexible overlays and mobility management in IP (Internet Protocol) networks and relates more particularly to a network architecture in which assembled logical devices form an overlay network on top of IP networks to effect numerous and diverse purposes. The present invention specifically serves as well the purpose of maintaining and supporting continuous connections between mobile hosts while minimizing the cost of the overlay structure and disruption to the existing network infrastructure.

### BACKGROUND OF THE INVENTION

The present invention builds upon two related background fields: overlay networks and mobility management for IP networks. These two fields are not only vast in and of themselves, they also overlap in the sense that overlay networks have been widely conceived in the use of supporting host mobility in IP networks. Ever since the rapid rise of the public Internet, the quest to create overlays over public networks has never stopped. A major driving force for this quest relates to the lack of a single entity capable of controlling the entirety of the Internet; the most practical way to effect Internet-wide applications without full control is to erect an overlay network. The concept of overlay has become exceptionally popular since the introduction of P2P (Peer to Peer) networking. Today, overlay networks of all kinds are deployed in numerous forms and for diverse purposes; nearly half of the Internet traffic today is overlay/P2P related. In a general sense, the popular end-to-end infrastructure used by numerous corporations and entities is a form of overlay network. The reasons for erecting overlay networks are numerous. The main reason may be that, since IP architecture was originally designed for a purpose different from today's wide-ranging purposes, numerous attempts have been made to generalize the basic service provided by the original Internet. The most common objectives of these attempts are to provide services such as multicasting, striping, anycasting, and host mobility.

There exist two main approaches for overlay IP networks: the IP-layer approach and the application-layer approach. The application-layer approach suffers from being application specific and inefficient in operations. Most of these schemes are tied to a specific class of applications and specific functionality (and, therefore, are not scalable to all applications). As a result, many similar and largely redundant mechanisms are required to achieve a general set of goals. The problem associated with IP-layer approaches is that most were found to be unscalable to widespread deployment. The present invention distinguishes itself by consisting of an IP-layer approach while being infinitely scalable in both size and application. A representative application-layer approach is that of SIP overlay. A representative IP-layer approach is that of i3, an overlay scheme developed at the University of California Berkeley.

Most overlay schemes suffer similar drawbacks when compared to the present invention. In addition, since all application overlay schemes are restrictive in their application scope, there is no need to compare the present invention to these schemes in detail. i3 will be compared against the present invention as a representative IP-layer overlay scheme.

i3 suffers from several deficiencies not shared with the present invention. The key idea of i3 is indirection: separating sending and receiving operations in the routing of IP packets through a process referred to as rendezvous. This scheme is based on a data-centric (where the concept of flows is replaced by the concept of data) framework and is contrasted against the flow-centric framework of the present invention. In a data-centric framework, it is very difficult if not impossible to exercise flow control. Fundamentally, flow control is equivalent to packet scheduling in the IP architecture and to schedule packet forwarding properly in a network it is imperative for packets to “flow” on fixed paths. Otherwise, it is impossible to predict accurately the arrival of packets at fixed locations. On the other hand, due to the flow-centric framework, it is just as easy to exercise routing and flow control in the present invention. In addition, because of the indirect nature of rendezvous routing, i3 overlay suffers from inefficient routing while the present invention exercises direct routing at all times, which in the end proves more efficient.

Further, i3 cannot achieve morphism (defined below; basically means flexibility in the overlay network infrastructure) in its fullest meaning. For instance, i3 cannot implement an end-to-end overlay network, because it always requires a rendezvous point in the network doing the triggers. The rendezvous point cannot be implemented at the terminals; it has to be implemented at the core of the network, possibly via a server with a global IP address (so any terminal can reach it). That itself is a limitation in terms of Morphism (or flexibility). The concept of c-forwarding of the present invention enables end-to-end overlay without any core infrastructure, while i3 cannot.

There is another closely related work called virtual connectivity (VC) from a group of researcher from Microsoft Research Asia (2003). While VC shares the similar idea that a flow ID is inserted into IP packets, it lacks the routing functions performed by the over-lay network infrastructure of the present invention.

The present invention does not require IP addresses of each of the overlay infrastructure node (later called c-nodes in the application); this is a highly distinctive feature of the present invention. The present invention is a control-centric scheme; this should be contrasted with i3 and VC; each of them is a data-centric scheme wherein the data plane and control plane are not differentiated clearly.

Host mobility on the Internet is the second background field of the present invention. The Internet was originally designed according to the assumption that all hosts were to be attached to the network at fixed locations. With the advent of mobile networking, the movement of hosts violates this basic assumption. Thus, the critical questions emerges of how to maintain continuous connections when hosts change network attachment points with minimal or no modification to the applications using the connections. This problem arises because TCP/UDP connections break when one of the hosts in the connection changes its IP address and/or port number.

The mobility problem has received a tremendous amount of attention. Some studies even claims that the problem is so severe that a new Internet architecture is required. Existing solutions are broadly classified into four categories: application-layer, transport-layer, IP-layer, and new-layer. Application-layer approaches include SIP, DDNS, and MOBIKE, among others. Transport-layer approaches include TCP extensions and modifications (I-TCP, MTCP, LMDR TCP option, TCP-R, MSOCKS, etc.), M-UDP, m-SCTP, and DCCP, among others. IP-layer approaches include Mobile IPv4/IPv6 and its enhancements and LIN6, among others. New-layer approaches include HIP and MAST, among others. The present invention consists of a “new-layer” approach where the “new layer” may be inserted anywhere above the IP layer. The layer is placed between quotation marks because the present invention allows “new-layer” headers to be inserted anywhere in the packet. The present invention employs the basic idea of connection ID.

Current solutions can be classified even more broadly as solving four aspects of the mobility problem: handover management, location management, multihoming, and application transparency. While these four aspects are sufficient to classify current solutions, they fail to clarify the 8 fundamental sub-problems associated with mobility problems, which are described below.

The present invention distinguishes itself by directly addressing 8 fundamental sub-problems of the mobility problem:

(A) Morphism: A problem whose solution requires the best mobility overlay network to be chosen among those characterized as end-to-end, gateway-based or mixed form, depending on the specific network conditions;

(B) One-sided NAT and firewall traversal: A problem whose mobility solution allows IP packets to traverse NAT (Network Address Translation) boxes and firewall boxes when one side of the connection is located behind such boxes;

(C) Double-sided NAT traversal: A problem whose mobility solution allows IP packets to traverse NAT boxes when both sides of the connection are located behind such boxes;

(D) Simultaneous movement: A problem whose mobility solution maintains continuous connections while both sides of a connection are mobile;

(E) Optimal versus triangular routing: A problem whose mobility solution allows optimal routes between mobile nodes when a fixed relay box is used between the two sides of the connection;

(F) Topologically correct mobility: A problem in which IP packets are dropped due to the router rule stating that the source IP address of incoming packets must belong to a permitted set of IP addresses;

(G) Total convergence: A problem whose solution entails that when two or more network links are simultaneously available, all the available network links are merged into a single link available at the IP-layer; and

(H) Total integration: A problem whose mobility solution allows all applications to run seamlessly without any modifications.

It appears that no known mobility solution except the present invention resolves all 8 fundamental sub-problems. For example, every application-layer mobility solution suffers from the total integration problem, as the solution is application specific. The industry default solution Mobile IPv4/IPv6 suffers from the simultaneous movement problem. All existing non-IP-layer solutions suffer from the total convergence problem. The closest to a solution yet found is practiced by WiBoost Network wherein a virtual connection is created to control and utilize the separate network links when 2 or more network links are available. On the other hand, the present invention provides a single connection using all available network links. All transport-layer approaches also suffer from the total integration problem, as all of them involve modifications to the transport layer protocols (TCP/UDP), which means that applications must be modified to work with the modified transport layer protocols. On the other hand, the present invention does not require any changes to transport layer protocols.

Additionally, as a result of searching for better means of mobility management for IP networks, it has become clear that the original IP architecture is too “rigid.” Despite being a tremendous success, IP protocol suites have increasingly been criticized as being too inflexible with regard to wide-ranging and rapidly evolving application requirements. For instance, by definition TCP connections (and therefore all the protocols that run on top of them, such as HTTP, FTP, TELNET, TCP-based video streaming, etc.) can only run in unicast mode and are bound to travel a fixed path constrained by the rule of “the best route given a destination IP address.” Another well-known example of “Internet rigidity” concerns host mobility: The Internet was designed according to the assumption that the IP addresses of two communicating end points would not change while the connection between them was active. This assumption is massively violated in today's mobile environments. In addition, NAT and firewall boxes (which today are often referred to as middle boxes) violate the fundamental assumption that every IP address is globally unique. While they used to suffer vigorous opposition in the IETF, middle boxes today are massively deployed on a worldwide basis. Even with the rapid deployment of IPv6, it has been generally agreed upon that middle boxes are here to stay. The existence of middle boxes is a major cause for the increasing complexity of protocols such as SIP/VoIP. All these developments have exposed IP rigidity; the call for softening the IP architecture has been heard loud and clear in every corner of the technological world.

### SUMMARY OF THE INVENTION

It is, therefore, an object of the present invention to supply a system and method for providing a simple yet flexible overlay network on top of any other IP network to enable diverse network applications where much of IP protocol suite rigidity is eliminated without any modifications to the applications.

Another object of the present invention is to supply a system and method for providing simple and flexible IP overlay networks to solve the general IP mobility problem, defined specifically below.

It is another object of the present invention to supply a system and method for providing simple and flexible IP overlay networks in order to enable unicast connections between two end points to utilize multiple paths and multiple network links which may originate from distinct network media and technologies.

It is another object of the present invention to supply a system and method for providing simple and flexible IP overlay networks to enable multicast, anycast, and any other conceivable connection between a group of sending end points and a group of receiving end points under the current IP architectures while avoiding any indirection in routing such as occurs in the i3 overlay architecture.

It is another object of the present invention to supply a system and method for providing simple and flexible IP overlay networks to enable any arbitrary but feasible scheduling of IP packet forwarding over the overlay.

It is another object of the present invention to provide a system and method for creating overlay networks within overlay networks over any underlying IP networks; wherein paths within paths and connections within connections constitute components of the overlay network.

In accordance with one aspect of the present invention, there is provided a method for associating a connection identifier (connection ID) with an individual connection between two groups of end points; wherein the connection ID is locally unique at any point inside the overlay network.

In accordance with one aspect of the present invention, there is provided a method for setting up logical devices of primitive kind to accomplish the full functionality of the overlay network.

In accordance with one aspect of the present invention, there is provided a method for IP packets with identical connection ID to traverse paths set up by the overlay network infrastructure.

In accordance with one embodiment of the present invention, there is provided a system comprising: a plurality of c-nodes; one or more source terminal nodes connected to an IP network; and one or more destination terminal nodes connected to the IP network, wherein the source terminal nodes send IP packets over the plurality of c-nodes to the destination terminal nodes to accomplish arbitrary communications between arbitrary groups of the source terminal nodes to arbitrary groups of the destination terminal nodes.

In accordance with one embodiment of the present invention, each of the IP packets is an ordinary IP packet or a c-packet, wherein the c-packet is an IP packet including an MTEG header, wherein the MTEG header contains a tetrad field and a CID field, wherein the tetrad field contains at least a source IP address, a source transport layer port number, a destination IP address and a destination transport layer port number, in an ordered format.

In accordance with one embodiment of the present invention, the MTEG header of the c-packet resides anywhere in the packet.

In accordance with one embodiment of the present invention, each of the c-nodes performs the operations of: receiving an input packet, wherein the input packet is an ordinary IP packet or a c-packet; producing a plurality of output packets, wherein each of the output packets is an ordinary IP packet or a c-packet; and forwarding the output packets to their respective destinations as ordinary IP packets.

In accordance with one embodiment of the present invention, each of the c-nodes is coupled with a status table, wherein each entry of the status table includes a tetrad list and a CID, wherein the tetrad list is a list of tetrads in an ordered format.

In accordance with one embodiment of the present invention, each of the c-nodes is coupled with a routing function unit, wherein in the operation of producing the output packets from the input packet, the routing function unit uses contents of the status table coupled with the c-node and the MTEG header of the input packet to produce the output packets.

In accordance with one embodiment of the present invention, at least one of the c-nodes performs the operation of: when the input packet is an ordinary input IP packet, inserting an MTEG header into the input packet to thereby produce a c-packet as the output packet.

In accordance with one embodiment of the present invention, at least one of the c-nodes performs the operation of: when the input packet is a c-packet, removing an MTEG header from the input c-packet to produce an ordinary IP packet as the output packet.

In accordance with one embodiment of the present invention, at least one of the c-nodes performs the operations of: when the input packet is a c-packet, determining a new MTEG header by the routing function unit; and swapping the MTEG header of the input c-packet with the new MTEG header; to thereby produce a modified c-packet as the output packet.

In accordance with one embodiment of the present invention, at least one of the c-nodes performs the operations of: when the input packet is a c-packet, duplicating a plurality of copies of the input c-packet, wherein the number of the copies is determined by the routing function unit; and determining a new tetrad for each copy of the input c-packet by the routing function unit; and modifying each copy of the input c-packet with the respectively determined new tetrad in the MTEG header, to thereby produce a plurality of modified c-packets as the output packets.

In accordance with one embodiment of the present invention, at least one of the c-nodes performs the operation of: when the input packet is a c-packet, receiving a sequence of input c-packets, wherein the number of the input c-packets is determined by the routing function unit; determining a new tetrad for each of the input c-packets by the routing function unit; and modifying each of the input c-packets with the respectively determined new tetrad in the MTEG header, to thereby produce modified c-packets as output packets.

In accordance with one embodiment of the present invention, the routing function unit guarantees that the c-packets related with a first source-destination terminal pair include a CID associated with the source-destination terminal pair, wherein the CID is different from CIDs of c-packets related with other active and distinct source-destination pairs at each of the c-nodes during an active communication life of the first source-destination terminal pair.

In accordance with one embodiment of the present invention, the CID associated with the first source-destination terminal pair remains unchanged during the active communication life of the first sources-destination terminal pair.

In accordance with one embodiment of the present invention, the status table is updated in response to an update signal from at least one of the source terminal, the destination terminal and another c-node.

In accordance with one embodiment of the present invention, the CID and the tetrad are recursively defined and stored in a vectored format.

In accordance with one embodiment of the present invention, there is provided a method employing the system, the method comprising: creating a plurality of unicast IP connections, wherein IP packets associated with the same unicast IP connection are delivered over a multi-path, multi-network mechanism.

### BRIEF DESCRIPTION OF THE DRAWINGS

The above and other objects and features in accordance with the present invention will become apparent from the following descriptions of preferred embodiments in conjunction with their accompanying drawings, in which:

FIG. 1 defines the IP host mobility problem;

FIGS. 2A and 2B set forth a morphism example: end-to-end (FIG. 2A) versus gateway based (FIG. 2B);

FIG. 3 illustrates the one-sided NAT traversal problem;

FIG. 4 illustrates the double-sided NAT traversal problem;

FIG. 5 illustrates the simultaneous movement problem;

FIG. 6 illustrates the triangular routing problem;

FIG. 7 illustrates the problem of topologically incorrect protocol;

FIG. 8 illustrates the problem of total convergence;

FIG. 9 illustrates the IP layer solution that enables total integration;

FIGS. 10A and 10B illustrate a c-labeled packet: in FIG. 10A, the template of a regular IP packet with an MTEG header (the label); in FIG. 10B, a specific example of a c-labeled packet in which the IP tetrad resides in the IP header and the CID resides in the MTEG header;

FIG. 11 illustrates the status table with one STE;

FIGS. 12A to 12E illustrate a list of c-nodes;

FIGS. 13A and 13B set forth the generic setup for outbound mobility (FIG. 13A) and inbound mobility (FIG. 13B);

FIGS. 14A and 14B illustrate C-morphism: end-to-end solution;

FIGS. 15A and 15B illustrate C-morphism: gateway-based solution;

FIGS. 16A and 16B illustrate C-morphism: relay solution; and

FIGS. 17A and 17B illustrate C-morphism: total convergence.

### DETAILED DESCRIPTION OF THE PRESENT INVENTION

The first key idea of the present invention is to provide 5 logical IP processing devices that can be interconnected to enable overlay network routing at the IP-layer. Expanding the basic IP forwarding function into the logical functions enables the concept of C-morphism (defined below), which solves the IP rigidity problem.

The second key idea is to expand the overlay-networking IP routing to include the concept of flows. Two advantages are immediate: (1) seamless handoffs in the mobile environment are enabled, and (2) flow control through packet scheduling is enabled. This is accomplished by utilizing the concepts of tetrad and flow ID, described below.

The third key idea is to solve the mobility management problem by formulating a generalized IP mobility problem whereby all the fundamental issues are clearly delineated. These fundamental issues are summarized in the form of 8 fundamental sub-problems.

The fourth key idea is, through solutions enabled by overlay networks, to solve the individual sub-problems in the generalized IP mobility problem through specific embodiments of the present invention.

To organize the description of the present invention, the following structure will be followed: (1) Basic definitions, (2) Generalized IP mobility problem, (3) Overlay network infrastructure, and (4) Specific embodiments.

### BASIC DEFINITIONS

In the present invention, the following definitions will be used:

IP node: A logical device with an IP address and the capability to process IP packets.

Terminal: An IP node that can be used by a human to interface with an IP network (e.g., a host computer, a mobile phone with GPRS connectivity, etc.).

MT (Mobile Terminal): A terminal that can move from one network location to another while one or more of its connections (e.g., TCP or UDP connections) are active.

CT (Corresponding Terminal): A terminal that is communicating with an MT at the other end-point of the connection.

MG (Mobile Gateway): A non-terminal IP node that performs specific operations to enhance mobility management.

An IP connection (or simply a connection) will be understood as a set of packets traveling from one terminal (TR1) to a second terminal (TR2), all carrying the same IP tetrad. An IP tetrad (or simply a tetrad) consists of: (1) TR1's IP address (ipa_tr1), (2) TR1's TCP or UDP port number (prt_tr1), (3) TR2's IP address (ipa_tr2) and (4) TR2's TCP or UDP port number (prt_tr2). The tetrad is organized into an ordered structure, as in [ipa_tr1, prt_tr1, ipa_tr2, prt_tr2] wherein symbols such as T, T1 or T2 indicate particular instances of tetrads; for example, T=[ipa_tr1, prt_tr1, ipa_tr2, prt_tr2].

Since IP tetrads are ordered vectors, packets traveling from TR1 to TR2 belong to a different connection than those traveling from TR2 to TR1. The most common examples of IP connections are TCP or UDP connections.

### Generalized IP Mobility Problem

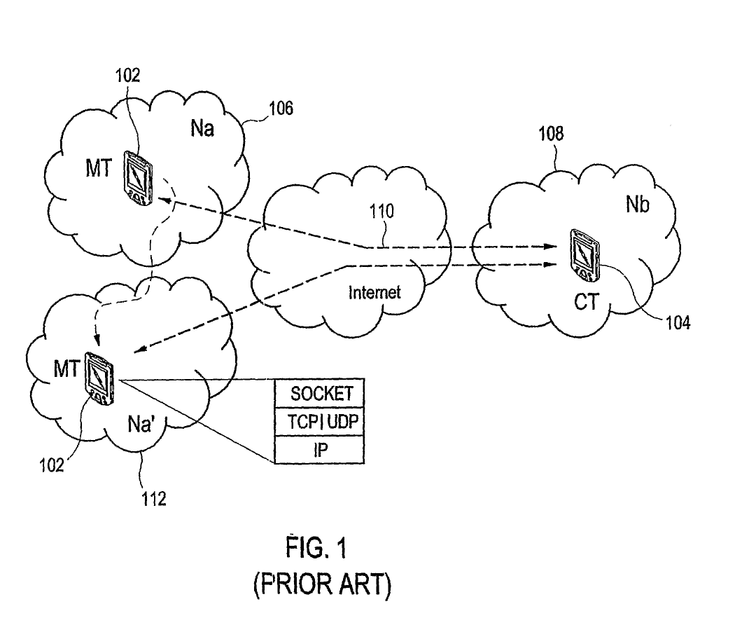

The generalized IP mobility problem will be understood as follows. Let MT 102 and CT 104 be two terminals attached to an IP network via networks Na 106 and Nb 108, respectively (FIG. 1). Suppose that MT 102 and CT 104 are exchanging data (bi-directionally) via an IP connection (e.g., a TCP or a UDP connection) 110. For the sake of descriptive simplicity, the connection 110 is assumed to entail both directions (from MT 102 to CT 104 and from CT 104 to MT 102). Suppose now that MT 102 moves from network Na 106 to another network Na′ 112 in such a manner that at the new network 112, MT 102 is assigned a new source IP address and source TCP or UDP port number (ipa_mt′ and prt_mt′, respectively). The generalized IP mobility problem focuses on protocol correctness and is described below.

The generalized IP mobility problem: How can connection 110 be maintained after MT 102 moves to the new network 112? This question can be broken down further into two sub-problems: (1) How can packets in connection 110 traveling from CT 104 to MT 102 be correctly routed after MT 102 moves to the new network 112? (2) How can packets in connection 110 traveling from MT 102 to CT 104 be correctly routed after MT 102 moves to the new network 112?

### (A) Morphism:

Because the Internet was not originally designed for mobile terminals, one of the challenges in developing IP mobility concerns the interoperability of legacy devices. In general, a solution should be inserted at certain points in the network to enable mobility while minimizing disruption. Depending on the requirements of specific network scenarios, certain locations will be more appropriate than others for insertion of the technology.

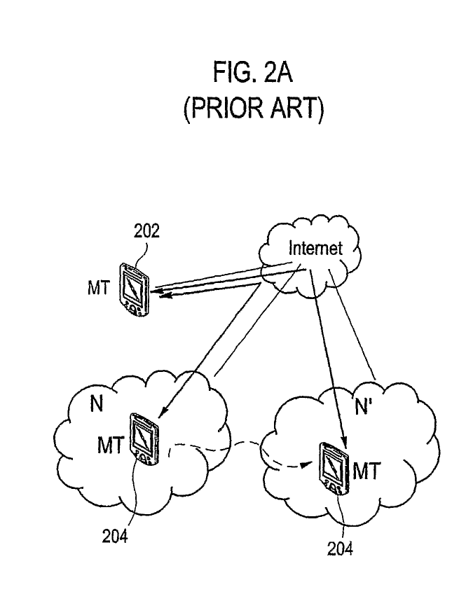

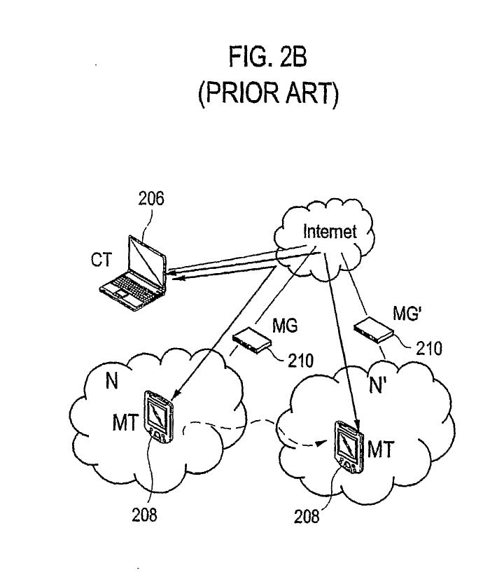

The capability of a mobility solution to adapt itself to multiple networking scenarios will be understood in the present invention as morphism. A common instance of morphism concerns the case of end-to-end versus gateway-based solutions, as shown in FIGS. 2A and 2B, respectively. In the end-to-end scenario, mobility technology is inserted only at end terminals 202 and 204. The advantage of this solution consists of the elimination of infrastructure at the core of the network, rendering the solution most scalable. In the gateway-based solution, the technology is inserted only at one of the terminals 206 and 208 and a certain amount of gateways are introduced at the core of the network. The advantage of this solution consists of allowing mobile terminal 208 to communicate with legacy non-mobile terminal 206.

### (B) One-Sided NAT and Firewall Traversal:

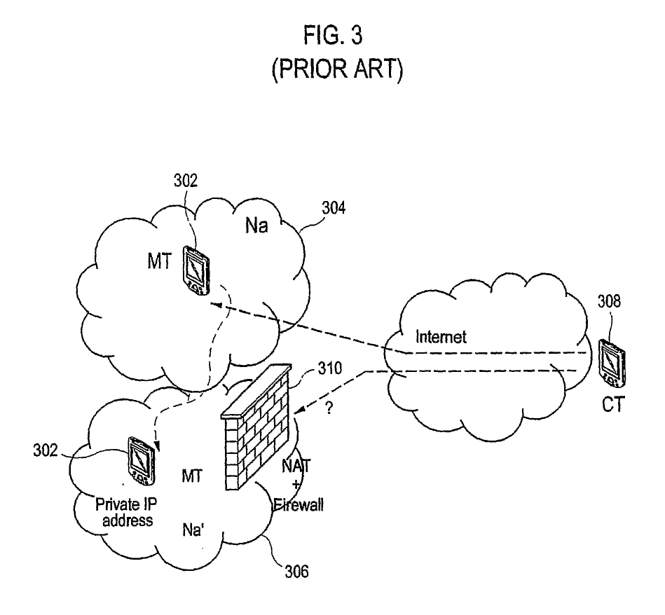

Today NAT boxes are massively deployed all across IP networks, making NAT traversal a necessity for most TCP-UDP/IP connections. Consider FIG. 3, wherein terminal MT 302 moves from network Na 304 to network Na′ 306. The scenario at hand assumes that network Na′ 306 is connected to the Internet through a NAT box. Therefore, upon moving to the new network Na′ 306, MT 302 will acquire not a public but a private IP address. Now the question arises: how can CT 308 send data to MT 302 if MT 302 acquires a private (and, therefore, a non-globally addressable) IP address?

Firewalls also tend to aggravate the problem of IP mobility, as shown in FIG. 3. (Most commercial NAT boxes are integrated with firewalls, as indicated by the reference numeral 310 in FIG. 3). In general, the existence of a firewall box in the communication path indirectly increases the complexity of the mobility problem since the mobility protocol needs to generate certain control packets (e.g., control packets exchanged between MTs, CTs, and MGs) that may not survive the traversing of the firewall, inducing a sort of “bootstrapping problem.” This problem will be referred to as the firewall-bootstrapping dilemma, or FBD.

An illustrative example of FBD appears in IETF document RFC 3519. This standard consists mainly of an amendment of RFC 2002 in providing a solution to the otherwise unresolved NAT traversal problem of Mobile IP. However, a solution requires the opening of UDP port 434 on all firewalls traversed along the communication path. Therefore, the technique employed to resolve the FBD is disruptive and introduces a potential security glitch. Solving the FBD without provoking such potentially destructive side effects is yet another benefit of the present invention.

### (C) Double-Sided NAT Traversal:

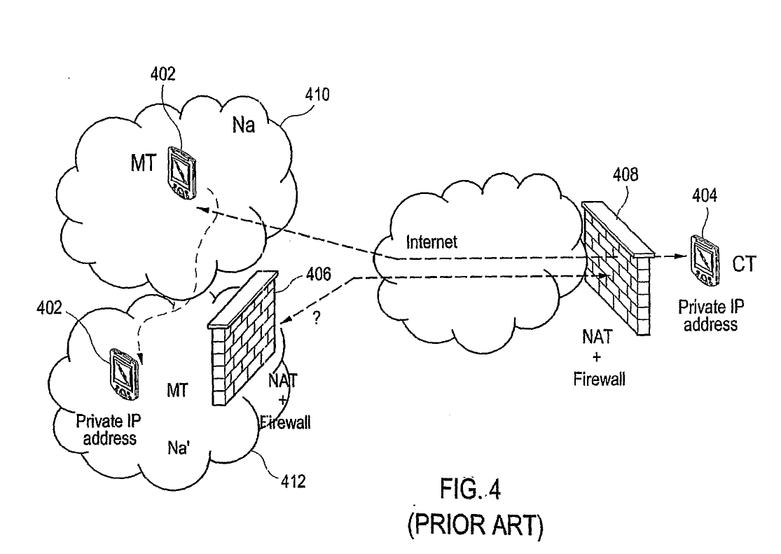

The double-sided NAT traversal problem arises from the scenario in which both MT 402 and CT 404 connect to the global Internet via NAT boxes 406 and 408 (FIG. 4). While the cause of the problem is the same as in the case of single-sided NAT traversal, the present invention identifies this scenario as a different class of problem since its solution requires a different type of technology, for unlike the single-sided case, the double-sided NAT traversal problem induces a deadlock situation:

Upon moving from network Na 410 to network Na′ 412, MT 402 cannot communicate to CT 404 since is the latter is positioned behind NAT 408 in which no hole has been punched for the new connection tetrad {ipa_mt′, prt_mt′, ipa_ct, prt_ct}. However, for CT 404 to punch a hole in its own NAT 408 to allow MT 402 communicate with CT 404, CT 404 must be aware of this action [ipa_mt′, prt_mt′], leading to a deadlock situation.

It can be proven that a solution to the double-sided NAT traversal problem requires a third element or box to act as a relay in the network. In the present invention, a relay box may be inserted to solve the deadlock problem easily.

### (D) Simultaneous Movement:

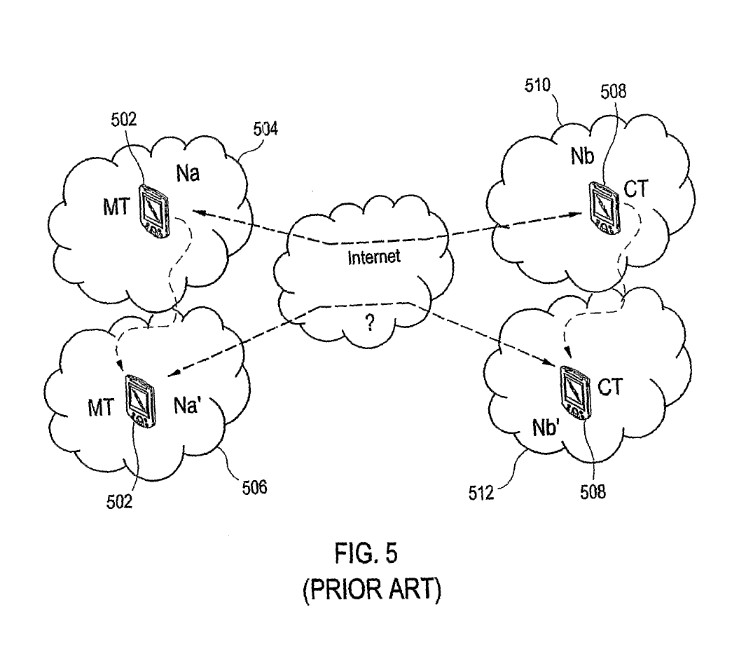

Consider FIG. 5 and suppose that MT 502 moves from Na 504 to Na′ 506. Likewise, suppose that CT 508 initiates a handoff from network Nb 510 to Nb′ 512. If CT 508 leaves network Nb 510 before MT 502 has concluded its transition to network Na′ 506, MT 502 and CT 508 are said to have simultaneously moved (the same applies to the case where the terms MT 502 and CT 508 are exchanged).

Notice that while the root cause of the simultaneous movement problem differs from that of the double-sided NAT traversal problem, both situations suffer the same consequences: both terminals lose contact with each other and are unable to exchange enough control information to finalize a handoff. Just as in the double-sided NAT case, a third element in the form of a relay box will be needed to resolve any simultaneous movement situation.

### (E) Optimal Versus Triangular Routing:

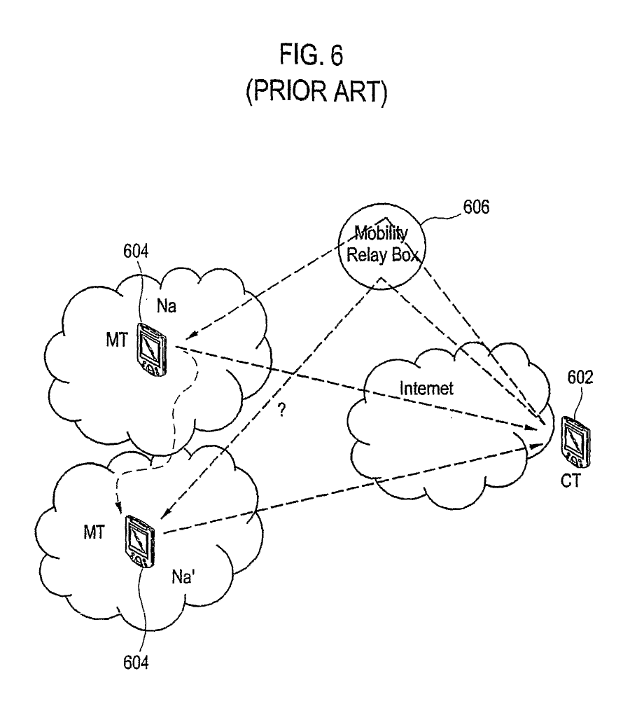

Triangular routing is a situation that arises due to mobility solutions that use fixed relay boxes. An example is presented in FIG. 6. If CT 602 is a static terminal, communication from CT 602 to MT 604 is always effected via mobility relay box 606, whereas communication between MT 604 and CT 602 can be accomplished directly. The advantage of using relay box 606 is that it allows the decoupling of the mobility problem from CT 602. From the standpoint of CT 602, MT 604 is just a fixed device with the IP address of relay box 606. This solution has an important drawback, namely that routing between CT 602 and MT 604 is not optimal. Triangular routing is routinely generated by the industry standard Mobile IPv4.

### (F) Topologically Correct Mobility:

Consider router R wjocj drops incoming packets based on the following topological rule: if ip_src is not in the set S the incoming packet is dropped, where ip_src is the source IP address of the incoming packet and S is the set of IP addresses belonging to the subnet in which R resides. An IP packet transmitted via the Internet is said to be topologically incorrect if it is dropped by a router due to this topological rule. This kind of packet dropping is also referred to as ingress filtering.

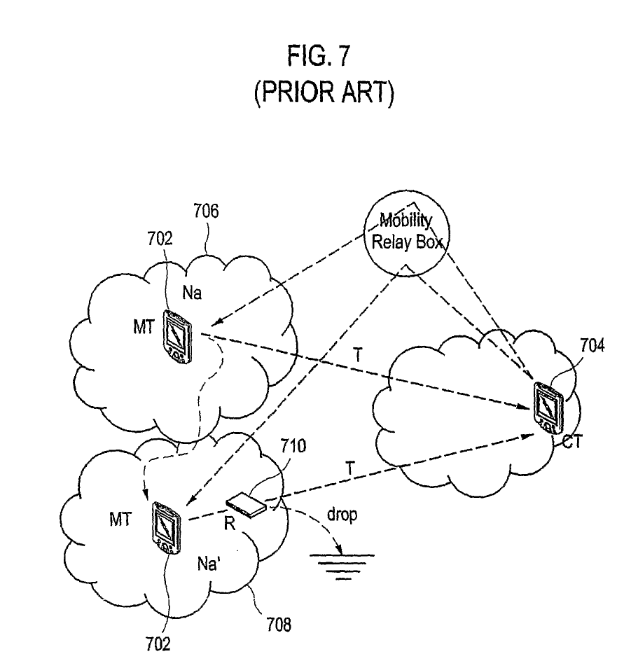

Now consider as an example the scenario presented in FIG. 7. Suppose that MT 702 is communicating with CT 704 using tetrad T=[ipa_mt, prt_mt, ipa_ct, prt_ct] and that MT 702 moves from network Na 706 to network Na′ 708. Since the mobility protocol uses triangular routing outgoing packets from MT 702 will go straight to CT 704 without traversing any relay box. If CT 704 is to accept packets from MT 702 after the latter has moved to Na′ 708, MT 702 must generate packets using the original tetrad T. Otherwise, packets arriving at CT 704 would not be delivered to the correct communication endpoint (in most IP stacks, this corresponds to the socket at CT 704's networking stack associated with tetrad T). But IP packets using tetrad T are topologically incorrect in network Na′ 708 and therefore are subject to being dropped by router R 710 within the same network (FIG. 7). In this case, the mobility protocol is said to be topologically incorrect.

### (G) Total Convergence:

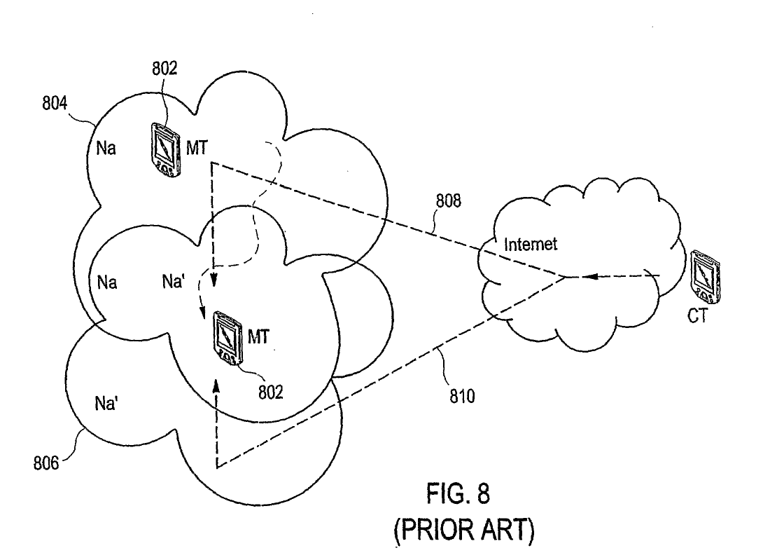

In the present invention, the term total convergence is defined as the ability of a solution to enable mobility across different IP networks (regardless of their physical and data link layers) in a seamless manner. For example, consider the situation shown in FIG. 8 wherein MT 802 has moved to the point of intersection between networks Na 804 and Na′ 806. Suppose that without dropping its connectivity 808 with network Na 804, the mobility protocol enables MT 802 to open communication path 810 through network Na′ 806. Now assume that MT 802 remains in the intersection area while maintaining connectivity to both networks Na 804 and Na′ 806. Therefore, through proper design, it is possible to enable simultaneous connectivity to services via multiple networks. More specifically, a totally convergent protocol is one that merges multiple network links (at the data link layer) to be made available to the IP-layer as a single link. A direct consequence of such a protocol is that a unicast connection will be able to effect multi-path delivery.

### (H) Total Integration:

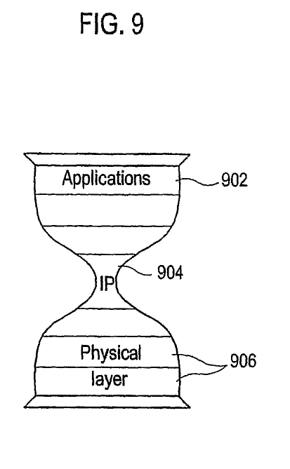

In the present invention, total integration is defined as the highest level of interoperability across both upper application-layer and lower physical-layer protocols. While some solutions to the mobility problem work only for specific applications and others operate only on top of specific physical-layer protocols (e.g., UMA), the present invention will be universal (enabling total integration) in the sense that mobility will be enabled for all applications and all physical-layer protocols. This is possible because the present invention is implemented purely at the IP layer. The universality of the present invention follows from the so-called sand clock principle of the Internet, according to which all application-layer protocols 902 run on IP 904 and all physical-layer protocols 906 run under IP 904 (FIG. 9).

### Overlay Network Infrastructure

In accordance with one embodiment of the present invention, overlay networking is accomplished by inserting at least a subset of 5 kinds of IP nodes (called c-nodes). Each c-node is attached an overlay-routing table called the status table (ST), whereby IP packets are routed according to tetrads and flow IDs.

The first kind of c-node performs c-forwarding, which is a simple but powerful operation whose primary objective is to make the Internet more flexible. This operation builds on IP networks and does not disrupt existing IP functionality. C-forwarding, for example, is completely compatible with IP forwarding.

A packet is said to be c-labeled if it carries a CID (connection identifier or convergence identifier), which may constitute a flow ID. The two requirements for a CID system are as follows:

(1) All packets of the same connection share the same CID; and

(2) The CIDs of any two packets of two arbitrary connections going through a common router differ one from the other.

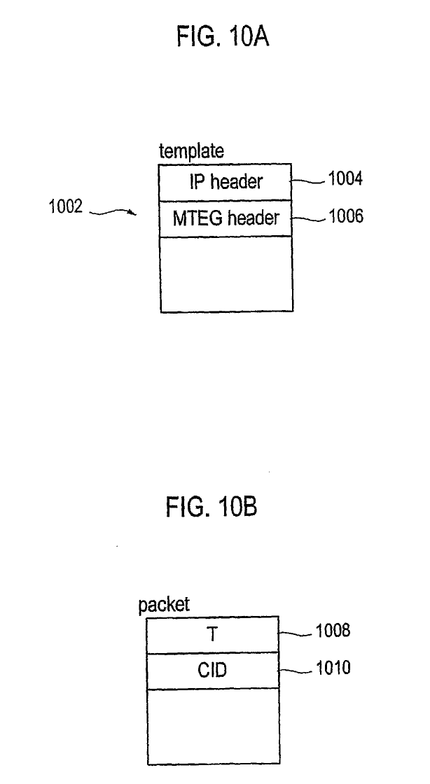

Given an IP node (e.g., an IP router), these two requirements allow the network to differentiate packets from two arbitrary connections going through this IP node. FIGS. 10A and 10B present a possible implementation of c-labeled packets. FIG. 10A represents possible template format 1002. All IP packets possess the IP header 1004 and c-labeled packets are labeled additionally with the header 1006, referred to in the present invention as the MTEG header. Notice that MTEG header 1006 can be located anywhere in the packet. FIG. 10B is an actual instance of general template 1002, showing that among all the fields in the packets headers, IP tetrads 1008 and CIDs 1010 comprise the main object of concern.

Following the same line of argument, given an IP connection (TCP or UDP connection), its c-path is defined as the set of IP nodes traversed by c-labeled packets from that connection.

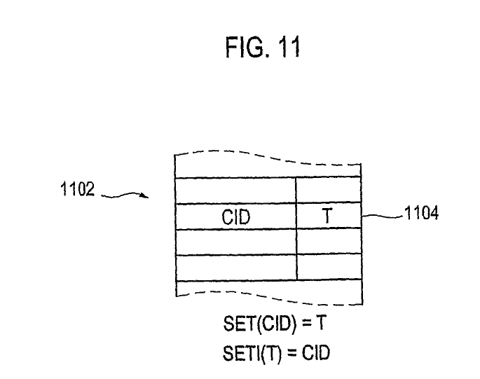

Now an IP node is said to be capable of c-forwarding if (1) it has status table 1102 (ST) in which each element 1104, referred to as STE or status table entry, maps a CID with an IP tetrad (FIG. 11), and (2) it performs c-forwarding operations. Given status table ST 1102, STE(CID) is used to denote the IP tetrad T associated with CID in ST 1102. Similarly, STEI(T) denotes the CID which has T as its associated IP tetrad in ST 1102 (where STEI stands for the inverse of STE).

Suppose that a c-labeled packet arrives at an IP node capable of c-forwarding. The c-forwarding operation at this IP node performs the following tasks: (1) Finding the STE in status table 1102 that matches the CID in the packet; (2) Changing the IP tetrad of the packet to that of the found STE 1104, i.e., STE(CID); (3) Based on the new IP tetrad, forwarding the packet using the normal forwarding procedures of the IP node (e.g., in the case of an IP router, IP forwarding is based on the new IP tetrad STE(CID) assigned to the packet).

Notice that if the tetrad found in STE 1104 is the same as the IP tetrad carried by the packet, c-forwarding becomes a NULL operation (i.e., having no effect). In fact, c-forwarding can be understood as a technique that generalizes any current IP forwarding scheme and, therefore, coexists and interoperates with all IP networks.

While c-forwarding defines the most natural atomic operation, there exists a set of logical nodes that can be defined and will be necessary to provide a complete framework. These nodes will be referred to as c-nodes.

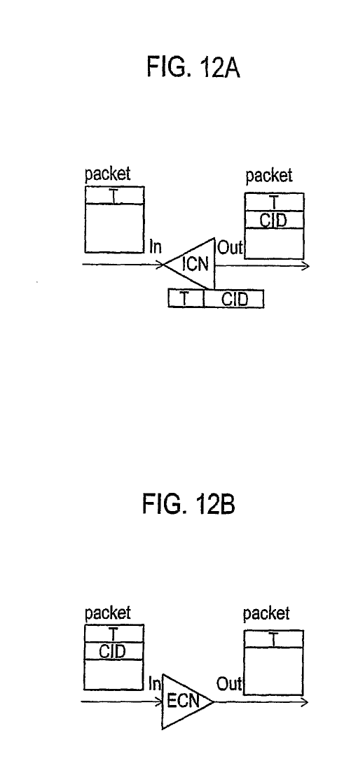

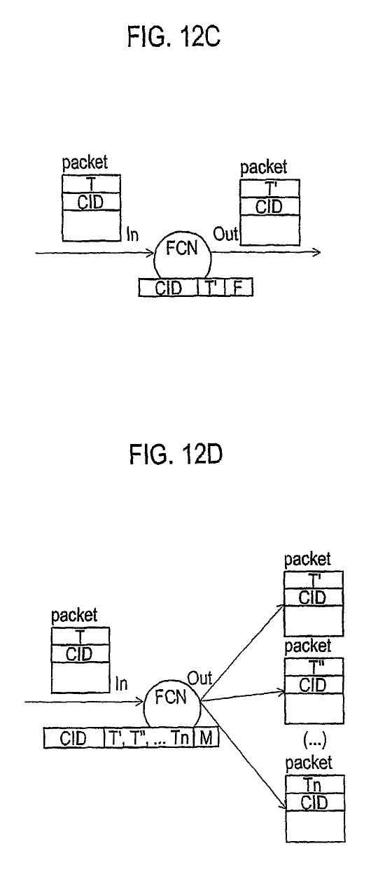

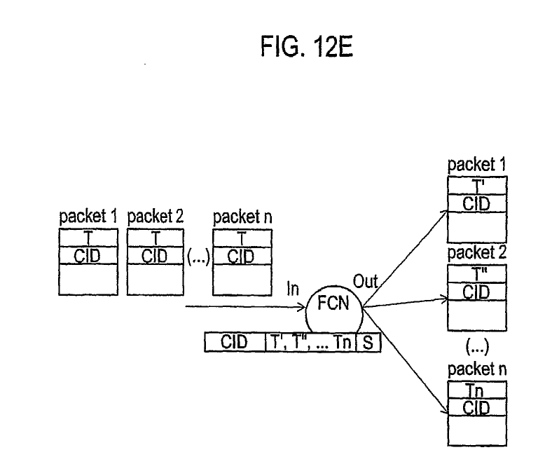

FIGS. 12A to 12E provide a graphical representation of some possible c-nodes:

ICN (ingress c-node; FIG. 12A): ICN performs the task of c-labeling packets and therefore defines the beginning of a c-path.

ECN (egress c-node; FIG. 12B): ECN performs the task of removing a c-label from a packet and therefore defines the end of a c-path.

FCN-F (forwarding c-node; FIG. 12C), a forwarding operation: FCN-F is a forwarding c-node that performs the basic c-forwarding operations as defined earlier.

FCN-M (forwarding c-node; FIG. 12D), a multicast operation: FCN-M is a forwarding c-node that performs multicasting. In this case, the found STE in the status table has n IP tetrads (n>1) where each incoming packet is duplicated n times and is updated with each of these tetrads before being forwarded by the underlying forwarding scheme.

FCN-S (forwarding c-node; FIG. 12E), a splitting operation: FCN-S is a forwarding c-node that performs splitting. The found STE in the status table has n IP tetrads (n>1) where each incoming packet uses one and only one of the tetrads (e.g., tetrads can be used on a round robin basis).

Because c-nodes define a mechanism to generalize the capabilities of IP protocols, they can be used in many different ways. One powerful application of c-nodes that will constitute the focus of the present invention concerns IP mobility.

From the above description, it will be apparent to one skilled in the relevant art that the overlay-network architecture in the present invention enables multicasting and splitting. Also from the above description, it will be apparent to one skilled in the relevant art that the overlay-network architecture in the present invention enables anycasting by modifying the status tables by some proper means.

Furthermore, from the above description, it will be apparent to one skilled in the relevant art that the overlay-network architecture in the present invention enables packet scheduling, thus enabling flow control functionality in the overlay-network. In addition, from the above description, it will be apparent to one skilled in the relevant art that the overlay-network architecture in the present invention enables paths within paths and connections within connections (as in ATM networks wherein a virtual path is equivalent to a group of virtual connections) by using a vectored form of the connection ID and status table.

### EMBODIMENTS

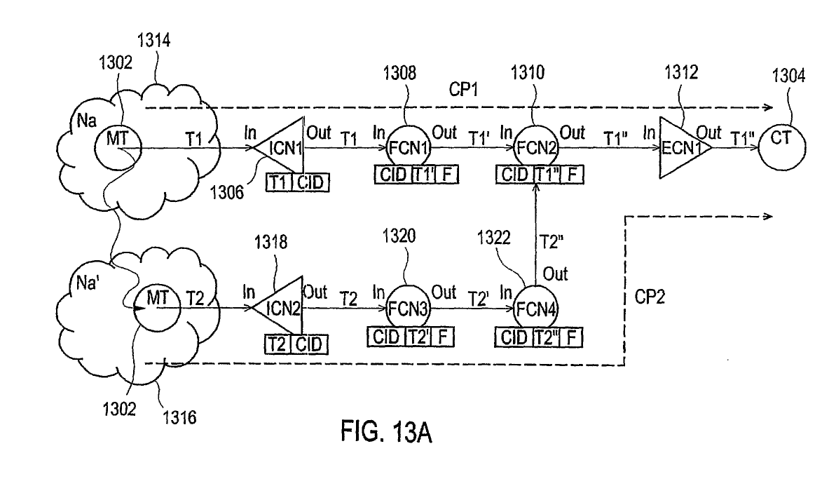

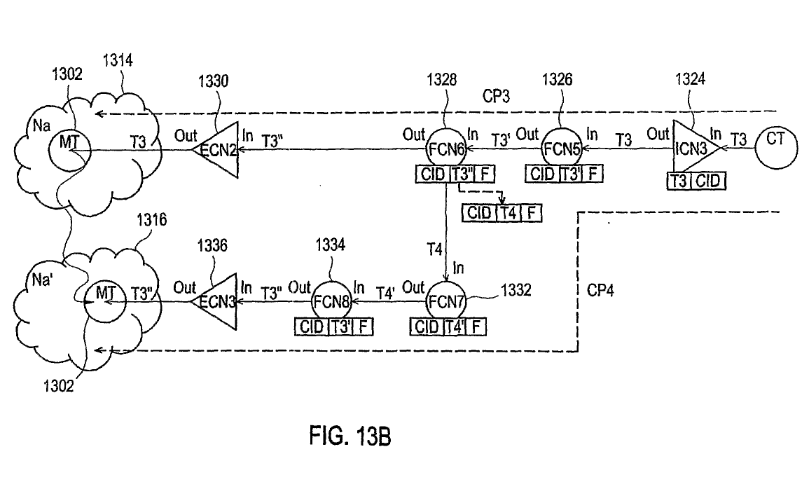

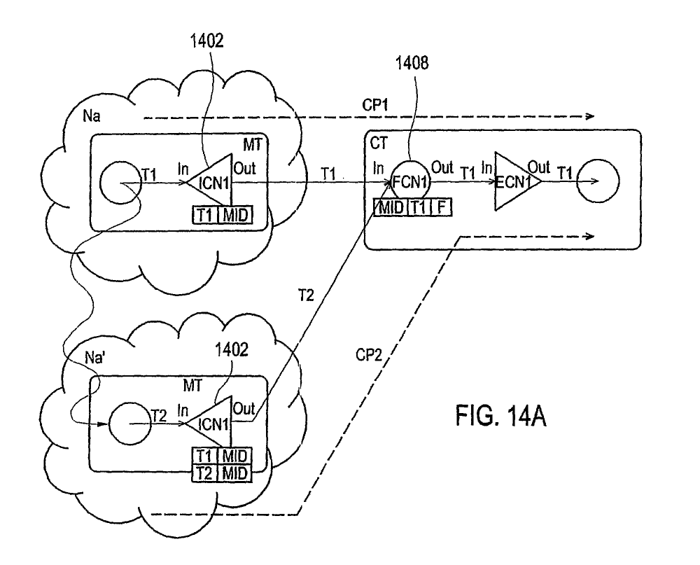

In accordance with one embodiment of the present invention, a generic setup with c-nodes for IP mobility is provided in FIGS. 13A and 13B. The mobility problem is broken down into two cases: an outbound case (FIG. 13A), in which data flows from MT 1302 to CT 1304, and an inbound case (FIG. 13B), in which data flows from CT 1304 to MT 1302. C-forwarding provides a generalization of current IP forwarding schemes and is completely interoperable with IP networks. Through the concept of c-nodes, functionalities can be added at certain strategic locations to resolve problems such as mobility and total convergence while coping with the constraints of a specific networking setup (e.g., end-to-end or gateway-based requirements).

Consider the case of outbound mobility. Packets going out from MT 1302 are intercepted by one ICN1 1306, which adds onto the packet a c-label. This defines the beginning of c-path CP1, which in the figure is terminated by MGs 1308 and 1310 and ECN 1312. Notice that this setup can be generalized in many different ways. Instead of 2 FCNs 1308 and 1310, for instance, the c-path could include any number of FCNs, defining an overlay network on top of the IP nodes. Upon moving from network Na 1314 to the new network Na′ 1316, MT 1302 starts generating packets with a different tuple, T2. Packets are intercepted by ICN2 1318 which defines the beginning of a new c-path, CP2. Notice that c-path CP2 is terminated by the same ECN as in the original c-path, CP1. CP2 could also be generalized to have an arbitrary number of FCNs. In the scenario at hand, CP2 has three FCNs, 1320, 1322, and 1310, the last one (FCN2 1310) being part of CP1, which allows packets to be correctly routed to CT 1304.

With a similar configuration the inbound mobility case is resolved. Outgoing packets from CT 1304 are intercepted by ICN3 1324, which defines the beginning of c-path CP3. This c-path is made up of 2 FCNs, 1326 and 1328, and one terminating ECN, 1330. After MT 1302 moves to Na′ 1316, a new c-path, CP4, is configured. FCN6 1328 is modified to map its STE entry associated with CID to a new IP tetrad T3″, i.e., STE(CID)=T3″, which allows inbound packets to be forwarded to FCN7 1332 and guarantees their correct routing to the new location.

The generality of the solution presented above will be demonstrated by transforming the configuration in FIG. 13 into new scenarios capable of resolving the requirements of specific networking scenarios. Each of these transformations will be referred to as a c-morphism.

In accordance with one embodiment of the present invention, an end-to-end C-morphism is accomplished as follows. This end-to-end configuration is achieved by applying the following transformation to FIG. 13:

(1) ICN1 1306 and ICN2 1318 are integrated into MT 1302 and become ICN1 1402;

(2) ECN1 1312 is integrated into CT 1304;

(3) ICN3 1324 is integrated into CT 1304 and becomes ICN2 1404;

(4) ECN2 1330 and ECN3 1338 are integrated into MT 1302 and become ECN2 1406;

(5) FCN1 1308, FCN2 1310, FCN3 1320, and FCN4 1322 are integrated into CT 1304 and become FCN1 1408;

(6) FCN5 1326 and FCN6 1328 are integrated into CT 1304 and become FCN2 1410; and

(7) FCN7 1332 and FCN8 are integrated into MT 1302 and become FCN3 1412.

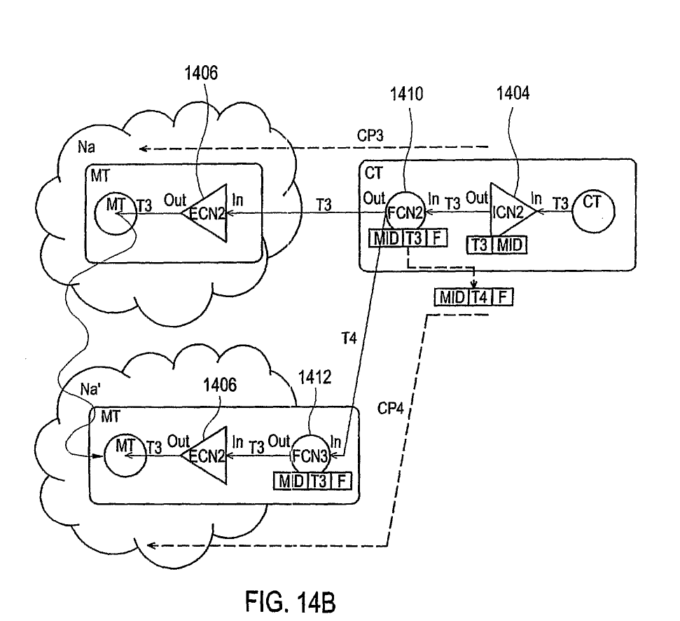

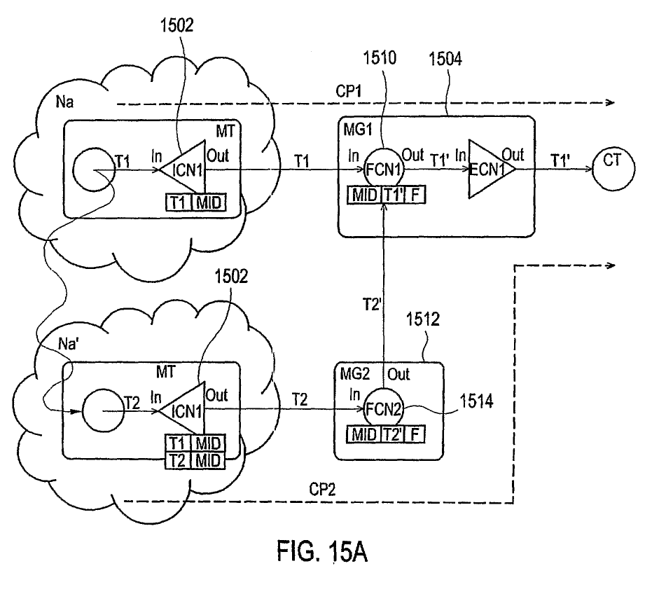

FIG. 14 illustrates this transformation. Notice that the morphism maintains all mobility capabilities while relocating the functionality of all the c-nodes to the terminals, leaving the core network untouched.

In accordance with one embodiment of the present invention, a gateway-based c-morphism is accomplished as follows. In this case, it is assumed that CT 1304 cannot be modified, i.e., that no c-node can be implemented inside the CT 1304. This is achieved by applying the following transformation to FIG. 13:

(1) ICN1 1306 and ICN2 1318 are integrated into MT 1302 and become ICN1 1502;

(2) ECN1 1312 is integrated into MG1 1504;

(3) ICN3 1324 is integrated into MG1 1504 and becomes ICN2 1506;

(4) ECN2 1330 and ECN3 1338 are integrated into MT 1302 and become ECN2 1508;

(5) FCN1 1308 and FCN2 1310 are integrated into MG1 1504 and become FCN1 1510;

(6) FCN3 1320 and FCN4 1322 are integrated into MG2 1512 and become FCN2 1514;

(7) FCN5 1326 and FCN6 1328 are integrated into MG1 1504 and become FCN3 1516;

(8) FCN7 1332 is integrated into MG2 1512 and becomes FCN4 1518; and

(9) FCN8 is integrated into MT 1302 and becomes FCN5 1520.

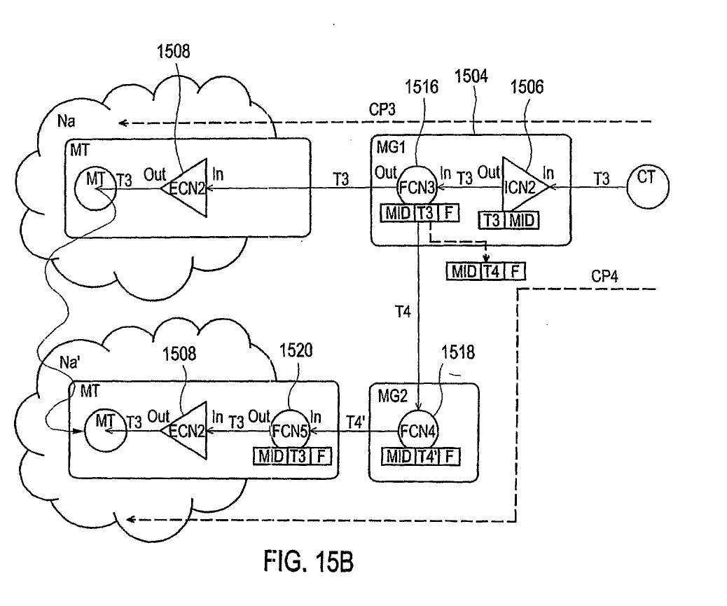

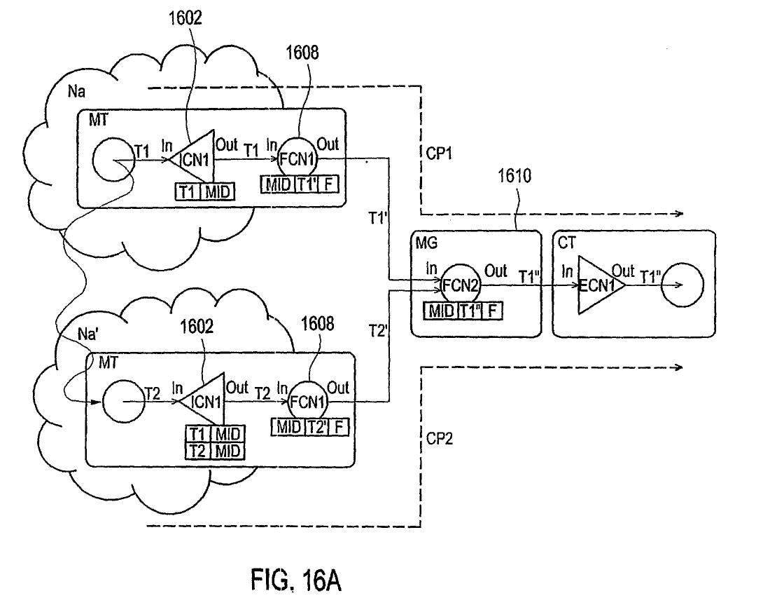

FIG. 15 presents the outcome of this transformation. Notice that this gateway-based c-morphism maintains all mobility capabilities while avoiding the insertion of any mobility technology inside CT 1304.

In accordance with one embodiment of the present invention, c-morphism of a relay box is accomplished through the following transformation:

(1) ICN1 1306 and ICN2 1318 are integrated into MT 1302 and become ICN1 1602;

(2) ECN1 1312 is integrated into CT 1304;

(3) ICN3 1324 is integrated into CT 1304 and becomes ICN2 1604;

(4) ECN2 1330 and ECN3 1338 are integrated into MT 1302 and become ECN2 1606;

(5) FCN1 1308, FCN3 1320, and FCN4 1322 are integrated into MT 1302 and become FCN1 1608;

(6) FCN2 1310 is integrated into MG 1610;

(7) FCN5 1326 is integrated into CT 1304 and becomes FCN3 1320 1612;

(8) FCN6 1328 is integrated into MG 1610 and becomes FCN4 1614; and

(9) FCN7 1332 and FCN8 are integrated into MT 1302 and become FCN5 1616.

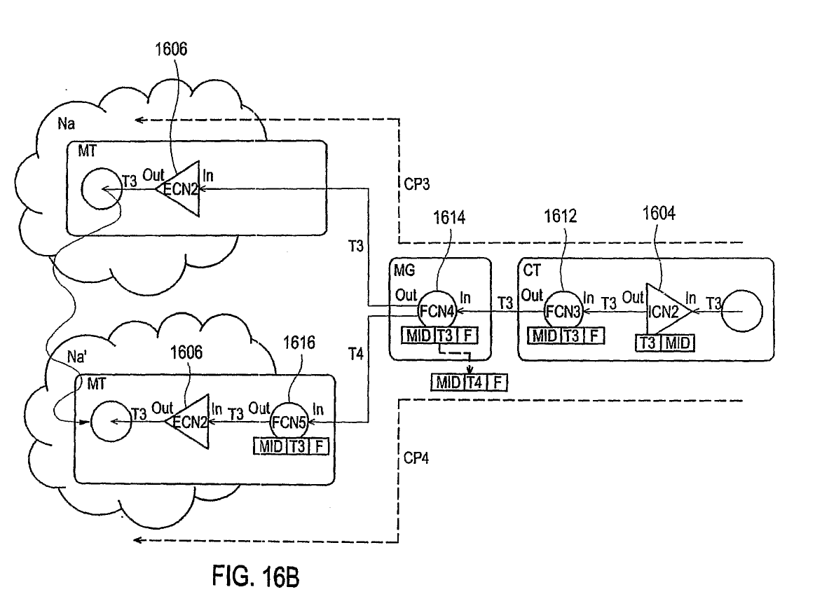

FIG. 16 illustrates the results of this morphism.

In accordance with one embodiment of the present invention, a total convergence c-morphism is accomplished as follows. By using a forwarding c-node in splitting mode, a transformation is initiated that will enable total convergence (as illustrated in FIG. 8). In the following morphism, the embodiment will enable multi-path communication on a connection that by standard IP protocols is unicast (e.g., a TCP or UDP connection). Notice, though, that even if the unicast IP connection is converted to enable multi-path connectivity, IP semantics (such as IP forwarding) are not disrupted by the c-morphism. Furthermore, an important consequence of the total convergence morphism is that it enables the logical aggregation of multiple networks into one (hence the term total convergence). For instance, with this morphism a single TCP connection is established using multiple paths concurrently, with each path routed on networks as diverse as WIFI, GPRS, CDMA EVDO, WIBRO, WIMAX, etc.

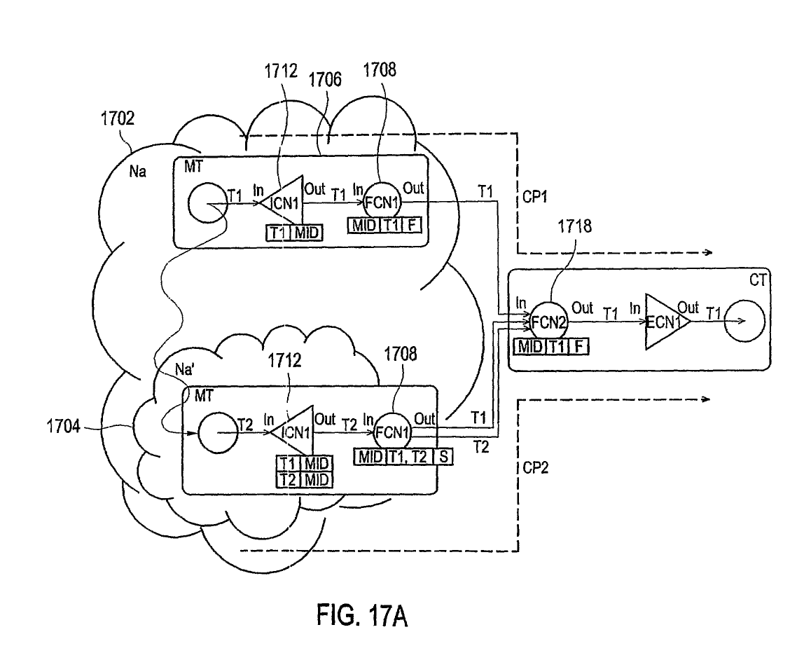

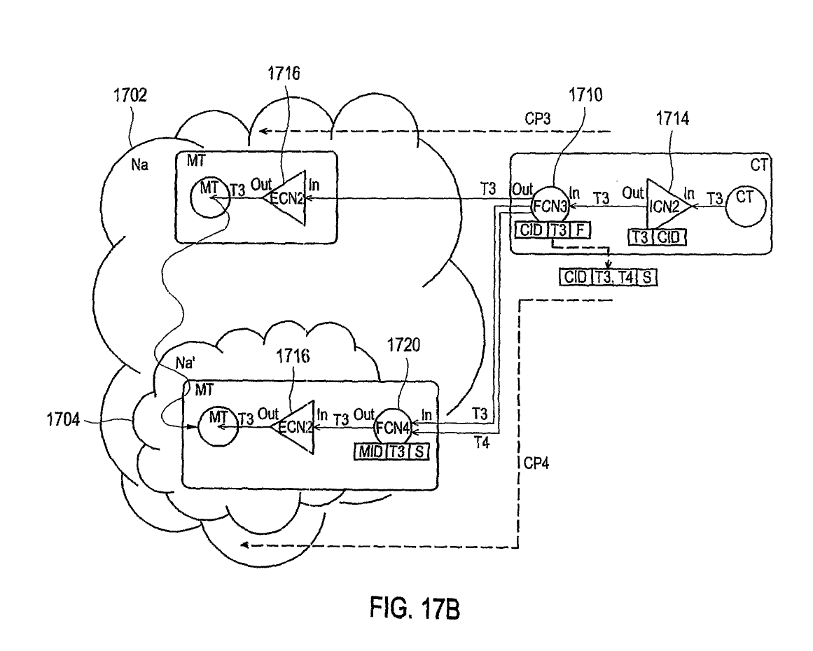

To provide an example, assume a scenario in which network Na 1702 includes network Na′ 1704 so that when MT 1706 moves to Na′ 1704 it still maintains connectivity with Na 1702. Notice that in this example an end-to-end configuration is used to demonstrate the concept of total convergence. Similar scenarios could be presented for other network configurations such as gateway-based or relay solutions. Finally, from FIG. 17 notice that once MT 1706 moves to Na′ 1704, FCN1 1708 and FCN3 1710 change the mode of operation of their STEs associated with MID from forwarding mode (F) to splitting mode (S). The transformation transpires as follows:

(1) ICN1 1306 and ICN2 1318 are integrated into MT 1706 and become ICN1 1712;

(2) ECN1 1312 is integrated into CT 1304;

(3) ICN3 1324 is integrated into CT 1304 and becomes ICN2 1714;

(4) ECN2 1330 and ECN3 1338 are integrated into MT 1706 and become ECN2 1716;

(5) FCN1 1308, FCN3 1320, and FCN4 1322 are integrated into MT 1706 and become FCN1 1708;

(6) FCN2 1310 is integrated into CT 1304 and becomes FCN2 1718;

(7) FCN5 1326 and FCN6 1328 are integrated into CT 1304 and become FCN3 1710; and

(8) FCN7 1332 and FCN8 are integrated into MT 1706 and become FCN4 1720.

While the present invention and its various functional components have been described in particular embodiments, it should be appreciated that the present invention can be implemented in hardware, software, firmware, middleware or a combination thereof and utilized in systems, subsystems, components or sub-components thereof. When implemented in software, the important elements of the present invention consist of the instructions/code segments used to perform the necessary tasks. The program or code segments can be stored in a machine-readable medium, such as a processor-readable medium or a computer program product, or transmitted by a computer data signal embodied in a carrier wave or a signal modulated by a carrier through a transmission medium or communication link. The machine-readable medium or processor-readable medium may include any medium that can store or transfer information in a form readable and executable by a machine (e.g., a processor, computer, etc.).

Furthermore, while the present invention has been illustrated and described with respect to a preferred embodiment, those skilled in the art will recognize that various changes and modifications may be made without departing from the scope of the invention as defined in the appended claims.

What is claimed is:

1. A system comprising:
a plurality of c-nodes;
one or more source terminal nodes connected to an IP network; and
one or more destination terminal nodes connected to said IP network,
wherein said source terminal nodes send IP packets over the plurality of c-nodes to said destination terminal nodes to accomplish arbitrary communications between arbitrary groups of said source terminal nodes to arbitrary groups of said destination terminal nodes.

2. The system of claim 1, wherein each of the IP packets is an ordinary IP packet or a c-packet, wherein the c-packet is an IP packet including an MTEG header, wherein the MTEG header contains a tetrad field and a CID field, wherein the tetrad field contains at least a source IP address, a source transport layer port number, a destination IP address and a destination transport layer port number, in an ordered format.

3. The system of claim 2, wherein the MTEG header of the c-packet resides anywhere in the packet.

4. The system of claim 3, wherein each of the c-nodes performs the operations of:
receiving an input packet, wherein the input packet is an ordinary IP packet or a c-packet;
producing a plurality of output packets, wherein each of the output packets is an ordinary IP packet or a c-packet; and
forwarding the output packets to their respective destinations as ordinary IP packets.

5. The system of claim 4, wherein each of the c-nodes is coupled with a status table, wherein each entry of the status table includes a tetrad list and a CID, wherein the tetrad list is a list of tetrads in an ordered format.

6. The system of claim 5, wherein each of the c-nodes is coupled with a routing function unit, wherein in the operation of producing the output packets from the input packet, the routing function unit uses contents of the status table coupled with the c-node and the MTEG header of the input packet to produce the output packets.

7. The system of claim 6, wherein at least one of the c-nodes performs the operation of:
when the input packet is an ordinary input IP packet, inserting an MTEG header into the input packet to thereby produce a c-packet as the output packet.

8. The system of claim 7, wherein at least one of the c-nodes performs the operation of:
when the input packet is a c-packet, removing an MTEG header from the input c-packet to produce an ordinary IP packet as the output packet.

9. The system of claim 8, wherein at least one of the c-nodes performs the operations of:
when the input packet is a c-packet, determining a new MTEG header by the routing function unit; and
swapping the MTEG header of the input c-packet with the new MTEG header;
to thereby produce a modified c-packet as the output packet.

10. The system of claim 9, wherein at least one of the c-nodes performs the operations of:
when the input packet is a c-packet, duplicating a plurality of copies of the input c-packet, wherein the number of the copies is determined by the routing function unit; and
determining a new tetrad for each copy of the input c-packet by the routing function unit; and
modifying each copy of the input c-packet with the respectively determined new tetrad in the MTEG header, to thereby produce a plurality of modified c-packets as the output packets.

11. The system of claim 10, wherein at least one of the c-nodes performs the operation of:
when the input packet is a c-packet, receiving a sequence of input c-packets, wherein the number of the input c-packets is determined by the routing function unit;
determining a new tetrad for each of the input c-packets by the routing function unit; and
modifying each of the input c-packets with the respectively determined new tetrad in the MTEG header, to thereby produce modified c-packets as output packets.

12. The system of claim 11, wherein the routing function unit guarantees that the c-packets related with a first source-destination terminal pair include a CID associated with the source-destination terminal pair, wherein the CID is different from CIDs of c-packets related with other active and distinct source-destination pairs at each of the c-nodes during an active communication life of the first source-destination terminal pair.

13. The system of claim 12, wherein the CID associated with the first source-destination terminal pair remains unchanged during the active communication life of the first sources-destination terminal pair.

14. The system of claim 12, wherein the status table is updated in response to an update signal from at least one of the source terminal, the destination terminal and another c-node.

15. The system of claim 12, wherein the CID and the tetrad are recursively defined and stored in a vectored format.

16. A method employing the system of claim 12, the method comprising:
creating a plurality of unicast IP connections, wherein IP packets associated with the same unicast IP connection are delivered over a multi-path, multi-network mechanism.
